(19) United States
(12) Patent Application Publication
(10) Pub. No.: US 2026/0217295 A1
(43) Pub. Date: Jul. 30, 2026

(54) STORAGE CHEST FOR A UTILITY CART

(71) Applicant: Apex Brands, Inc., Apex, NC (US)

(72) Inventors: Jesse HIGGINS, Raleigh, NC (US); Robert WARREN, Charlotte, NC (US); Zhihong FU, Cary, NC (US); Kyle ROMANICK, Fuquay-Varina, NC (US)

(21) Appl. No.: 19/137,046

(22) PCT Filed: Dec. 4, 2023
(86) PCT No.: PCT/US2023/082253

§ 371 Date: Jun. 9, 2025

Related U.S. Application Data
(60) Provisional application No. 63/431,845, filed on Dec. 12, 2022.
(60) Provisional application No. 63/468,565, filed on May 24, 2023.

(51) Int. Cl. B62B 3/02; B25H 1/12

(52) U.S. Cl. CPC B62B 3/02; B25H 1/12

(57) ABSTRACT

A utility cart may include a handle via which a user may move the utility cart, a top support platform, to which the handle may be operably coupled, a bottom support platform which may be parallel to the top support platform, at least one upright support member which may operably couple the bottom support platform to the top support platform, a mobility assembly which may be operably coupled to the bottom support platform, and a storage chest which may be disposed within a perimeter of, and removably operably coupled to, the top support platform.

### TECHNICAL FIELD

Example embodiments generally relate to utility carts and, in particular, relate to utility carts that are provided with a storage chest for improved utility and versatility.

### BACKGROUND

Utility carts may be commonly used in various settings ranging from dedicated workspaces such as labs, garages, and warehouses or other storage facilities to miscellaneous settings such as in offices, homes, restaurants, and many more. Within the various settings that utility carts may be used, utility carts may also be used for various purposes including but not limited to transporting objects, storing objects, working on objects, displaying objects, and many more. Utility carts may essentially be ubiquitously used in any sort of productive setting involving objects that may be desirable to transport due to their widely applicable and often simple design allowing the cart to be a useful resource in a large amount of use cases.

Existing utility carts may be rather simplistic and outdated in their design considering how they have come to be commonly used today. In this regard, users of utility carts may be using utility carts for more, and different, tasks than in the past. As such, there may be a need to develop an improved design for a utility cart that may be better suited for the increasingly wide variety of tasks for which utility carts may be utilized.

### BRIEF SUMMARY OF SOME EXAMPLES

Some example embodiments may provide for a utility cart. The utility cart may include a handle via which a user may move the utility cart, a top support platform, to which the handle may be operably coupled, a bottom support platform which may be parallel to the top support platform, at least one upright support member which may operably couple the bottom support platform to the top support platform, a mobility assembly which may be operably coupled to the bottom support platform, and a storage chest which may be disposed within a perimeter of, and removably operably coupled to, the top support platform.

Some example embodiments may provide for an accessory support assembly for a utility cart. The accessory support assembly may include a handle via which a user may move the utility cart, at least one extension arm which may operably couple the handle to the top support platform, and a storage chest which may be shaped to be disposed within a perimeter of, and removably operably coupled to, the top support platform. The storage chest may be lockable to securely store objects inside the storage chest on the utility cart.

Some example embodiments may provide for a storage chest for a utility cart. The storage chest may include a base portion which may include a bottom surface and a plurality of walls disposed substantially perpendicularly to the bottom surface, and a lid which may be pivotably operably coupled to the plurality of walls and disposed a height of the plurality of walls away from the bottom surface. The storage chest may be shaped to be disposed within a perimeter of, and removably operably coupled to, a top support platform of the utility cart.

The storage chest may be lockable to securely store objects inside the storage chest on the utility cart. The lid may be pivotable between an open position in which access into the base portion may be permitted by the lid and a closed position in which access into the base portion may be prohibited by the lid.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a utility cart according to an example embodiment;

FIG. 2 illustrates a perspective view of the utility cart having a storage chest according to an example embodiment;

FIG. 3 illustrates a perspective view of the utility cart having the storage chest according to an example embodiment;

FIG. 4 illustrates a perspective view of the utility cart having a storage chest according to an example embodiment;

FIG. 5 illustrates a perspective view of the utility cart having the storage chest according to an example embodiment;

FIG. 6 illustrates a perspective view of the storage chest removed from the utility cart in accordance with an example embodiment;

FIG. 7 illustrates a perspective view of the storage chest removed from the utility cart in accordance with an example embodiment;

FIG. 8 illustrates a top view of the storage chest in the utility cart with the lid removed in accordance with an example embodiment;

FIG. 9 illustrates an exploded view of the storage chest and the top support platform of the utility cart in accordance with an example embodiment;

FIG. 10 illustrates a perspective view of the bottom side of the utility cart in accordance with an example embodiment;

FIG. 11 illustrates a close up perspective view of the bottom side of the utility cart taken from box 11 in FIG. 10 in accordance with an example embodiment; and

FIG. 12 illustrates a section view of the storage chest in the utility cart in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

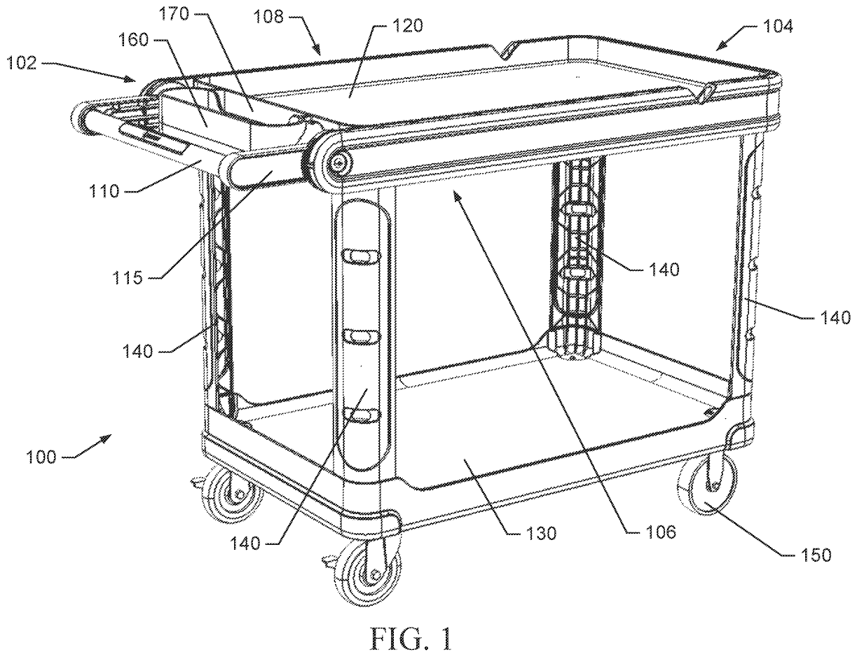

As indicated above, some example embodiments may relate to the provision of a utility cart 100 with an improved design. Referring now to FIG. 1, the utility cart 100 may include a handle 110, a top support platform 120, a bottom support platform 130, upright support members 140 and a mobility assembly. In some embodiments, the handle 110 may be a bar that may be disposed a distance away from the utility cart and may be operably coupled to the utility cart 100 at the top support platform 120 to allow for a user of the utility cart 100 to apply forces to move and steer the utility cart 100. When viewed from above, the utility cart 100 may have a substantially rectangular shape. In this regard, the utility cart 100 may have a first end 102 and a second end 104 and a first side 106 and a second side 108. The first end 102 and the second end 104 may both be equal to each other in length and shorter than each of the first side 106 and second side 108 of the utility cart 100. Thus, in some embodiments, the handle 110 may be operably coupled to the utility cart 100 at the first end 102 of the utility cart 100 proximate to the top support platform 120 so that the handle 110 may be at a comfortable position for the user of the utility cart 100 to interact with. The handle 110 of some example embodiments may also be adjustable. In this regard, the handle 110 may operably couple to the top support platform 120 via at least one extension arm 115. The at least one extension arm 115 may be pivotably operably coupled to the top support platform 120 such that an angle formed between the at least one extension arm 115 and the top support platform 120 may be adjustable. The handle 110 may therefore be fixed in whatever angle or position the user may desire via operable coupling of the at least one extension arm 115 to the top support platform 120.

The top support platform 120 may be disposed a distance above the bottom support platform 130 and supported by the upright support members 140. In some embodiments, there may be four total upright support members 140 supporting the top support platform 120, with one upright support member 140 disposed at each corner of the utility cart 100. It should be noted that in some other embodiments, more or fewer upright support members 140 may be used to support the top support platform 120. The top and bottom support platforms (120, 130) may both be planar surfaces substantially parallel to each other that may be capable of supporting objects thereon. In some cases, the top support platform 120 and the bottom support platform 130 may each include a lip that extends around the entire perimeter of each of the top and bottom support platforms (120, 130) that may help retain objects on respective support platforms by prohibiting the objects from rolling off the utility cart 100.

In some cases, some parts of the utility cart 100 may be formed from structural foam. In this regard, the top and bottom support platforms (120, 130), the handle 110, and some of the accessories described below may be formed from the structural foam. In some embodiments, the structural foam may be a black or gray color which may be a traditional appearance for many structural foams. The use of structural foam to construct the cart 100 may allow the cart 100 to achieve a higher stiffness-to-weight ratio than standard injection molded utility carts while also being more cost effective to produce. In some cases, products formed from structural foam may achieve a weight reduction of approximately 10-20% compared to their injection molded counterparts. However, the utility cart 100 of some embodiments may also include portions that are formed via an injection molding process. In this regard, the upright support members 140 may be injection molded from impact modified polypropylene, which may allow for the upright support members 140 to be colored without impacting the structural integrity of the cart 100.

Operably coupled to an underside of the bottom support platform 130 may be the mobility assembly, which may include a plurality of wheels 150. In some cases, the utility cart may include a total of four wheels 150, though more or less may also be used in other cases. The wheels 150 may be disposed at each of the four corners of the utility cart 100 shown in FIG. 1 in order to maximize the balance of the utility cart 100 and limit instability of the cart 100. In an example embodiment, all of the wheels 150 on the utility cart may be caster wheels. In such cases, all of the wheels 150 may be capable of turning 360° to allow the utility cart 100 to travel in any direction regardless of the orientation of the cart 100. In some other cases, the two wheels 150 disposed at the first end 102 may be caster wheels and the two wheels disposed at the second end 104 may be fixed wheels. In this regard, the utility cart 100 may be capable of being steered from the handle 110 at the first end 102 responsive to the caster wheels being capable of turning in any direction. In another example embodiment, the two wheels 150 disposed at the second end 104 may be caster wheels and the two wheels disposed at the first end 102 may be fixed wheels. In this regard, the utility cart 100 may be capable of being steered at the second end 104 via the handle 110 responsive to the caster wheels being capable of turning in any direction. In some cases, the wheels 150 may be fitted with a parking brake on each wheel 150. Each parking brake may immobilize the respective wheel 150 to which it may be operably coupled. With the parking brake for each wheel 150 engaged, the utility cart 100 may be held in place and may not roll anywhere. This feature may be useful when work may be done on the utility cart 100 itself, or in other cases where the cart 100 may roll away from the user unintentionally.

In some embodiments, the utility cart 100 may further include a storage pocket 160. The storage pocket 160 may be disposed between the handle 110 and the top support platform 120 in order to be easily accessible by the user of the utility cart 100. The storage pocket 160 may be capable of storing a number of objects of many different varieties. For example, the storage pocket 160 may store hand tools, writing utensils, or other miscellaneous objects of similar sizes. The storage pocket 160 may be disposed a distance away from the handle 110 due to the extension arms 115 extending away from the top support platform 120. In some cases, the distance between the handle 110 and the storage pocket 160 may vary since the position of the handle 110 may be adjustable. The storage pocket 160 may be disposed between two extension arms 115 of the handle 110. In this regard, there may be excess space on either longitudinal end of the storage pocket 160 between the storage pocket 160 and the extension arms 115. This space may provide some buffer between the storage pocket 160 and the extension arms 115 so that any objects stored in the storage pocket 160 do not interfere with the adjustment of the position of the handle 110 via the extension arms 115. In some cases, the space between the longitudinal ends of the storage pocket 160 and the extension arms 115 may account for approximately 10% of the total length of the handle 110, or a total distance between the two extension arms 115. In other words, the storage pocket 160 may have a length that is approximately 90% of the total length of the handle 110, or the total distance between the two extension arms 115.

The utility cart 100 may further include a technology receptacle 170 disposed between the storage pocket 160 and the top support platform 120. The technology receptacle 170 may be designed to support a personal electronic device, such as a mobile phone device or a tablet device, in a position where the personal electronic device may be used or viewed by the user of the utility cart 100. As such, the technology receptacle 170 may keep the personal electronic device separate from the storage of other objects within the storage pocket 160 to prevent any interference of the personal electronic device due to objects in the storage pocket 160. In contrast with the technology receptacle 170, the storage pocket 160 may be designed to hold a variety of tools, materials and objects that the user may want to keep separate or more accessible than objects in either of the top or bottom support platforms (120, 130). In an example embodiment, the distance between the storage pocket 160 and the handle 110 may not exceed a width of the storage pocket 160 measured between a shared wall with the technology receptacle 170 and a front wall of the storage pocket 160 closest to the handle 110. In some other cases, the distance between the storage pocket 160 and the handle 110 may be within a range of approximately 50-75% of the width of the storage pocket 160. This may ensure that there is sufficient space between the storage pocket 160 and the handle so that they may not interfere with each other as the user may interact with the handle 110 or the storage pocket 160. In an example embodiment, the technology receptacle 170 may have an overall length that is approximately 75% of the length of the storage pocket 160. In other words, the overall length of the technology receptacle 170 may be approximately 50-60% of the total length of the handle 110, or the total distance between the two extension arms 115. In an example embodiment, the top support platform 120 may be wider than the handle 110 is long. In other words, the length of the handle 110 may be approximately 90% of a width of the top support platform 120. Similarly, the length of the technology receptacle 170 may be approximately 40-50% of the width of the top support platform 120.

Thus, the technology receptacle 170 may hold the user's personal electronic device therein. For example, in a scenario where the utility cart 100 may be used for order fulfillment situations, the personal electronic device may contain a list of items needed to fulfill a particular order. Thus, the user of the cart 100 may need to easily see the screen of the personal electronic device being supported in the technology receptacle 170. In this regard, the technology receptacle 170 may provide stability of the personal electronic device disposed in the technology receptacle 170 so that the movement of the utility cart 100 does not knock over the personal electronic device. Additionally, the technology receptacle 170 may be designed to provide the user with an ergonomic view of the display of the personal electronic device so that the user of the utility cart 100 does not need to strain to view the device.

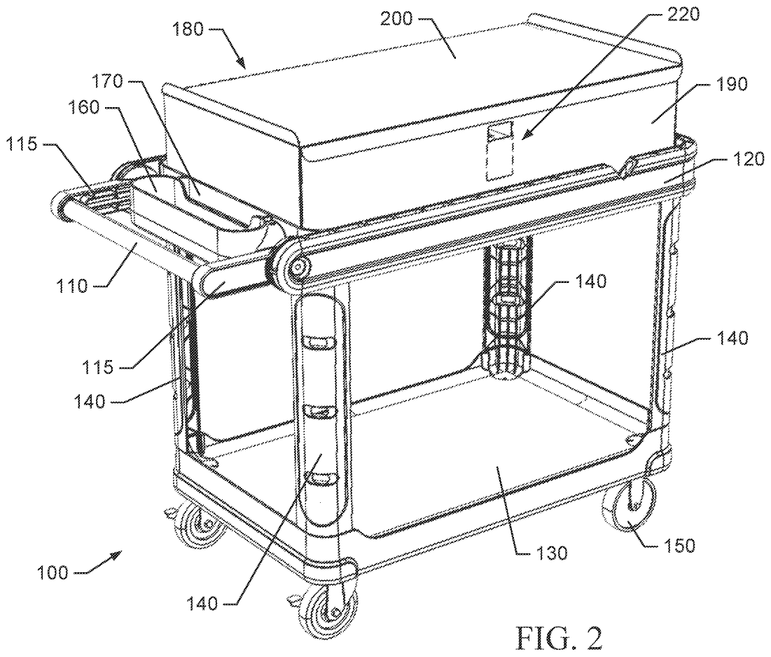

FIGS. 2-5 illustrate perspective views of the utility cart 100 having a storage chest 180 disposed in the top support platform 120 in accordance with an example embodiment.

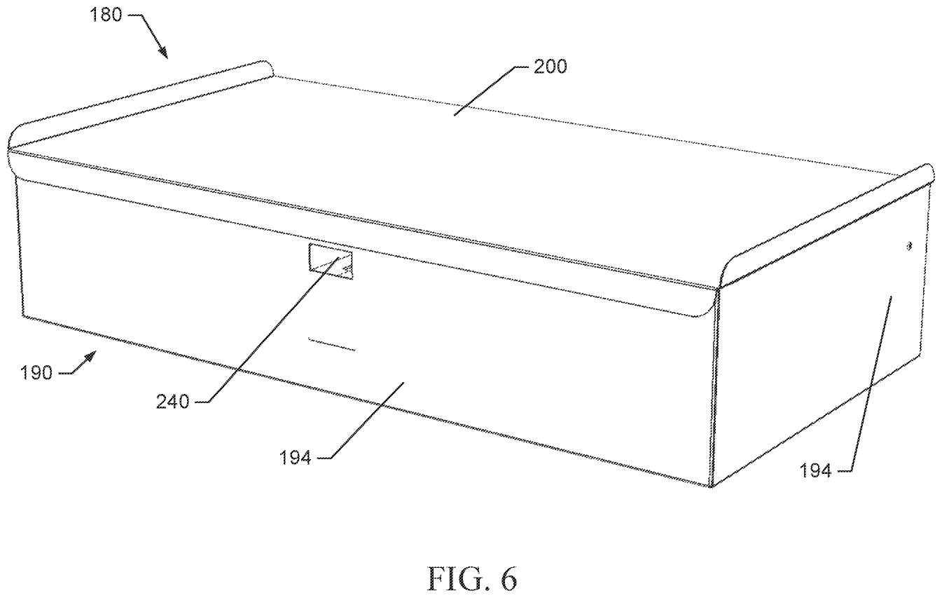

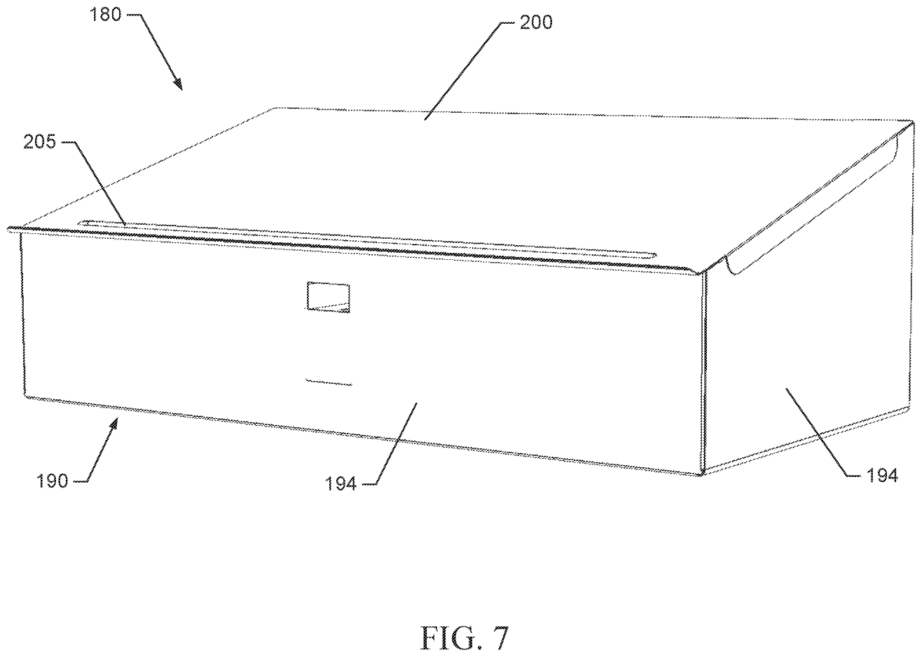

FIGS. 6 and 7 depict perspective views of the storage chest 180 removed from the utility cart 100 according to respective example embodiments. In some cases, the storage chest 180 may include a base portion 190 and a lid 200. In an example embodiment, the base portion 190 may include a bottom surface 192 and a plurality of walls 194. The bottom surface 192 may be substantially planar and disposed proximate, and parallel, to a surface of the top support platform 120, while the plurality of walls 194 may be disposed substantially perpendicularly to the bottom surface 192 and inside the lip disposed at the perimeter of the top support platform 120. In this regard, a perimeter of the storage chest 180 may be shaped to be disposed within the lip of the top support platform 120. With the storage chest 180 disposed in the top support platform 120, part of the top support platform 120 may remain accessible on both the first side 106 and the second side 108 of the utility cart 100. In other words, the storage chest 180 may occupy a full length of the top support platform 120 between the first end 102 and the second end 104 of the utility cart 100, but due to the corners of the top support platform 120 being rounded, the storage chest 180 may not occupy a full width of the utility cart 100 between the first side 106 and the second side 108.

The lid 200 may be pivotably operably coupled to the base portion 190 at a top of the plurality of walls 194, distal to the bottom surface 192. As such, the lid 200 may be disposed a distance away from the bottom surface 192 which may be equal to a height of the plurality of walls 194. In an example embodiment, the storage chest 180 may be made from sheet metal. In some cases, the storage chest 180 may be made from any other suitable rigid materials capable of forming the structure of the storage chest 180, such as a plastic polymer or high density structural foam. In any case, the base portion 190 may be formed from a single sheet of material which may be formed continuously into the shape of the bottom surface 192 and the plurality of walls 194. In an example embodiment, the storage chest 180 may fit within the perimeter of the top support platform 120, and the bottom contour of the storage chest 180 may be designed to match the contour of the top support platform 120 in order to maximize usable storage volume inside the chest 180 and provide the best possible fit and finish of the storage chest 180 within the cart 100.

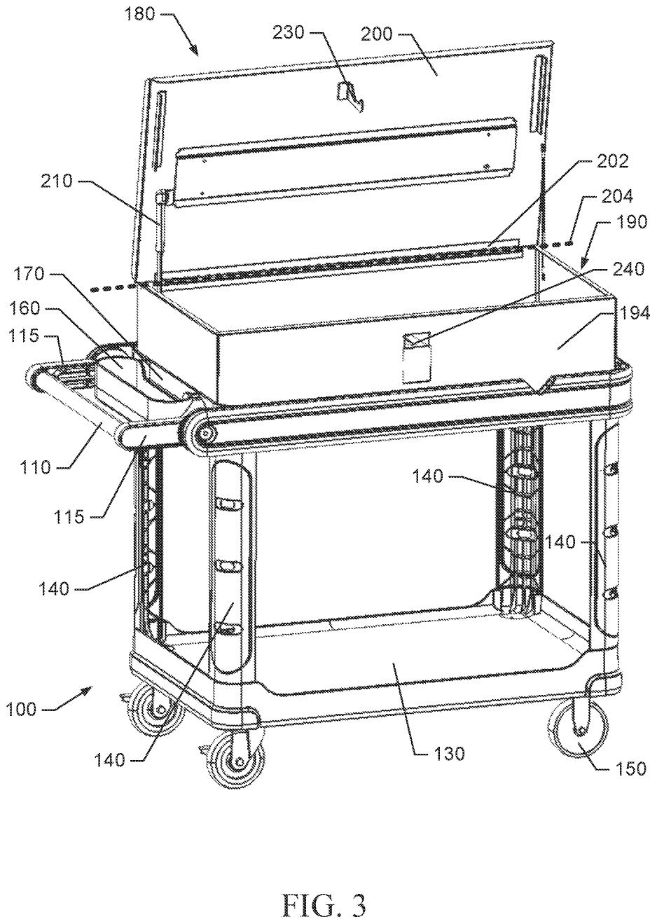

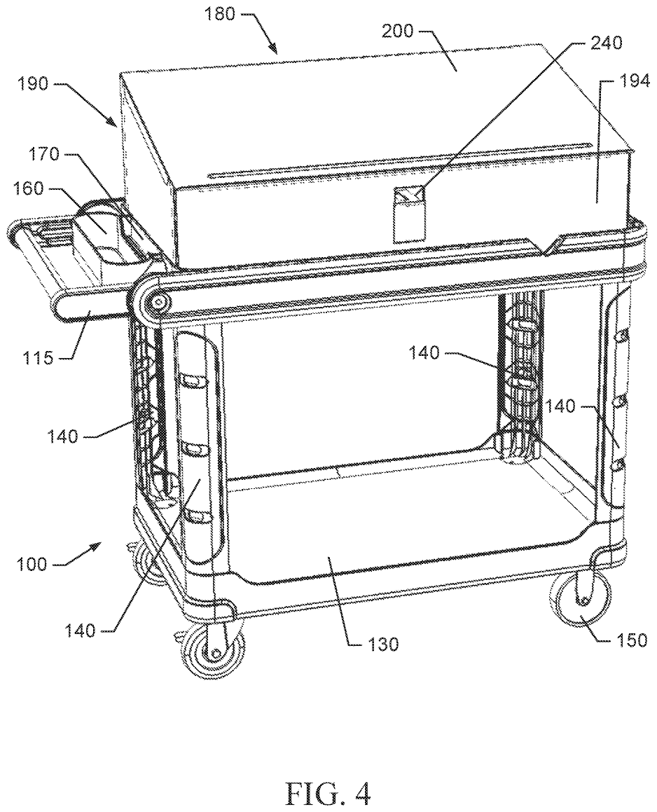

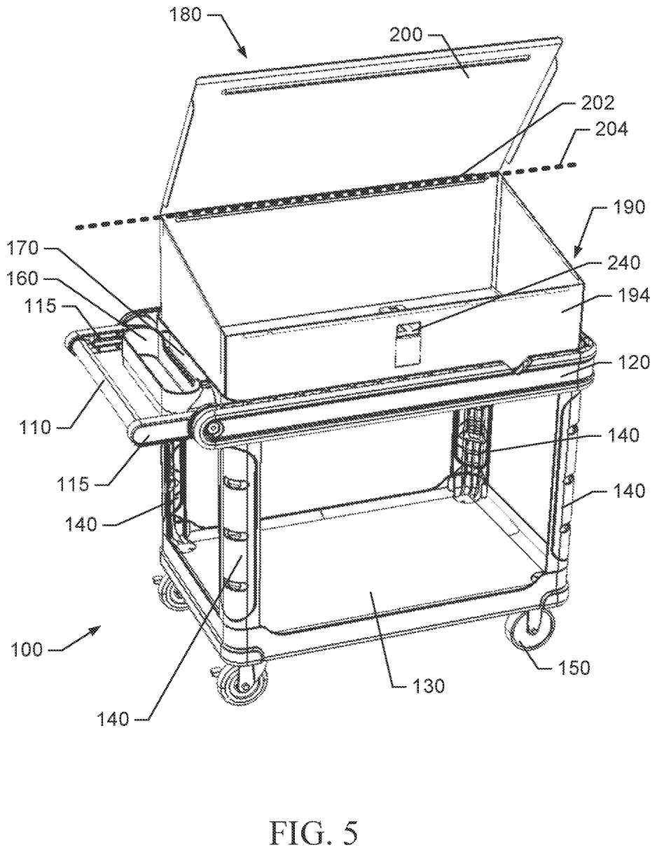

The lid 200 may be pivotable about a hinge 202 defining a pivot axis 204 which may extend through the hinge 202. Thus, the lid 200 may allow the user to access the interior of the base portion 190 and any contents disposed therein as they desire. As such, the lid 200 may be pivotable between an open position in which access into the base portion 190 may be permitted by the lid 200, and a closed position in which access into the base portion 190 may be prohibited by the lid 200. FIGS. 2, 4, 6 and 7 depict the storage chest 180 according to respective example embodiments in which the lid 200 is in the closed position, and FIGS. 3 and 5 depict the storage chest 180 according to respective example embodiments in which the lid 200 is in the open position. In some cases, as shown in the embodiments of FIGS. 2, 3 and 6, the storage chest 180 may include a level lid 200. In this regard, when in the closed position, the lid 200 may be substantially parallel to the bottom surface 192. On the other hand, as shown in the embodiment of FIGS. 4, 5 and 7, the storage chest 180 may include an angled lid 200. In this regard, when in the closed position, the lid 200 may form an angle with the bottom surface 192. In some cases, the angle of the lid 200 may be greater than 0° and less than 90°. In some embodiments, the angle of the lid 200 may be approximately 30°. In some cases, the angled lid 200 may be preferred in order to view documents and drawings on top of the storage chest 180 at an ergonomic viewing angle. The flat lid 200 may be preferred in other cases where the user may require an extra work surface and the ability to support objects on the lid 200 with greater ease.

In some cases, the storage chest 180 may be magnetic. In this regard, the user may utilize magnets to keep documents or other objects held onto the storage chest 180 accordingly. In an example embodiment, the lid 200 of the storage chest 180 may include a retaining ledge 205 for a writing utensil. The retaining ledge 205 may be disposed at an exterior side of the lid 200, and may be configured to prevent objects from falling off the lid 200 while the lid 200 is in the closed position for embodiments of the storage chest 180 having the angled lid 200. In any case, the user may have a convenient position to store a writing utensil in the even the user needs to mark the documents held on top of the lid 200. In an example embodiment where the storage chest 180 may have the angled lid 200, the retaining ledge 205 may be disposed on a lower end of the lid 200 and may extend parallel to an edge of the lid 200, on a distal end of the lid 200 from the hinge 202.

The storage chest 180 of some example embodiments may also include at least one gas strut 210 that may assist the user in opening the lid 200 of the storage chest 180 and may also assist in keeping the lid 200 in the open position while the user may be working with the contents disposed within the storage chest 180. In some cases, the lid 200 may include an entire top portion of the storage chest 180. In this regard, the lid 200 may have substantially the same area as the bottom surface 192. Whereas in some other cases, the lid 200 may only include a smaller portion of a top surface of the storage chest 180. In this regard, the lid 200 may have a smaller area than the bottom surface 192, and thus the top surface of the storage chest 180 may be divided into the lid 200 and another cover portion which may also be pivotable relative to the base portion 190 or may be fixed in place.

In the embodiments of FIGS. 2-7, the lid 200 of the storage chest 180 may be lockable to allow for the secure storage of objects within the interior of the storage chest 180. The locking mechanism 220 may include a locking arm 230 which may be disposed on an underside of the lid 200 and may extend substantially away from the lid 200. With the lid 200 in the closed position, the locking arm 230 may extend down into a locking cavity 240 disposed at an interior region of the base portion 190 and operably coupled to the inside of the plurality of walls 194. The locking cavity 240 may be configured to receive a padlock therein from the outside of the storage chest 180. Thus, the padlock may operably couple to the lid 200 via the locking arm 230 inside the locking cavity 240, and may alternatingly lock and unlock the lid 200 to the base portion 190 accordingly.

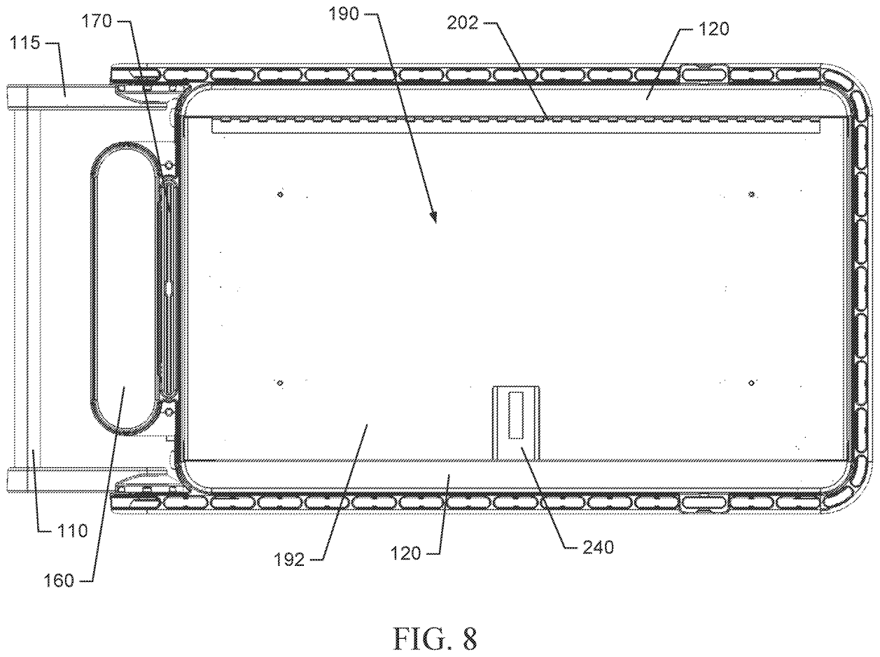

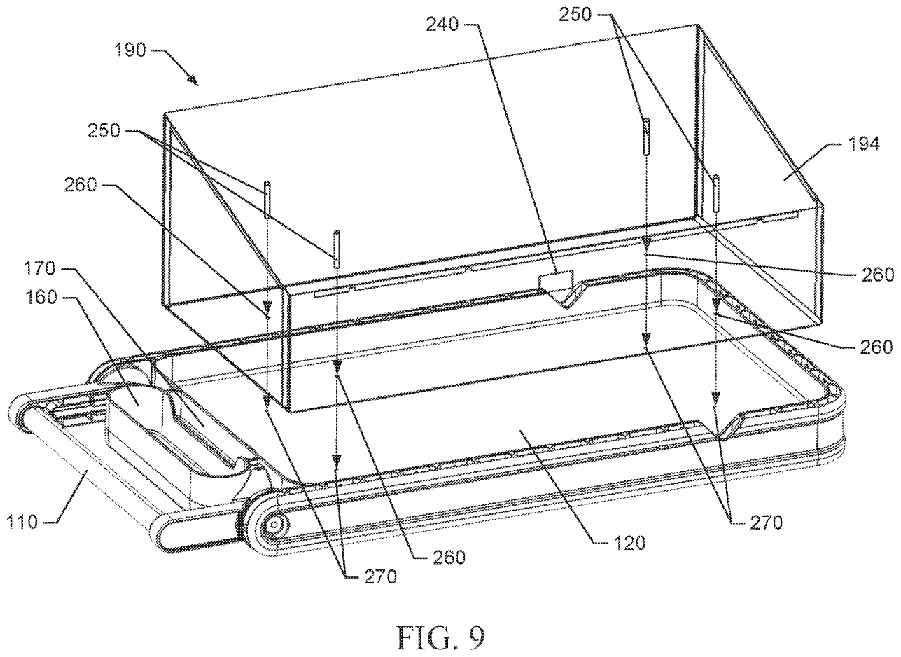

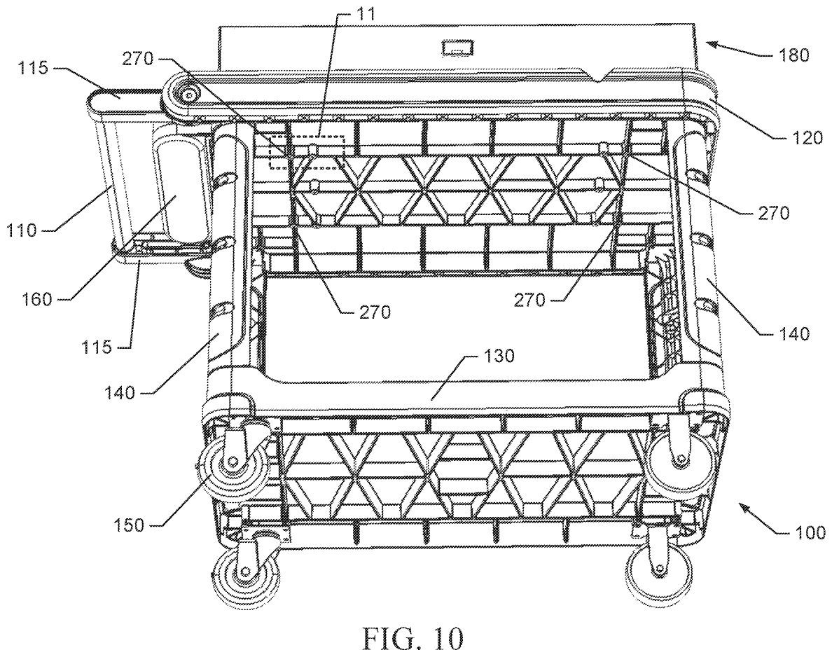

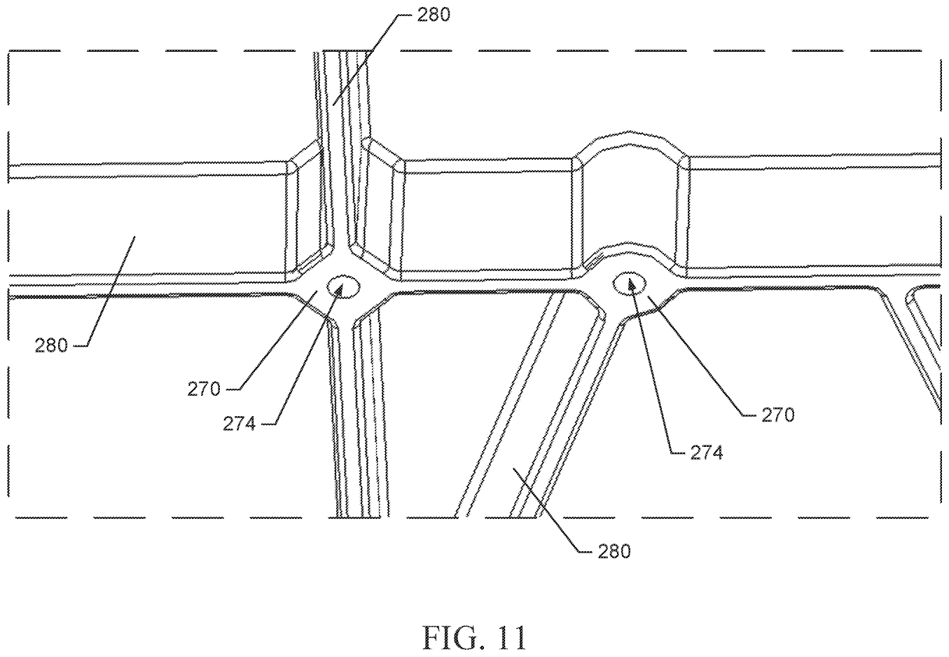

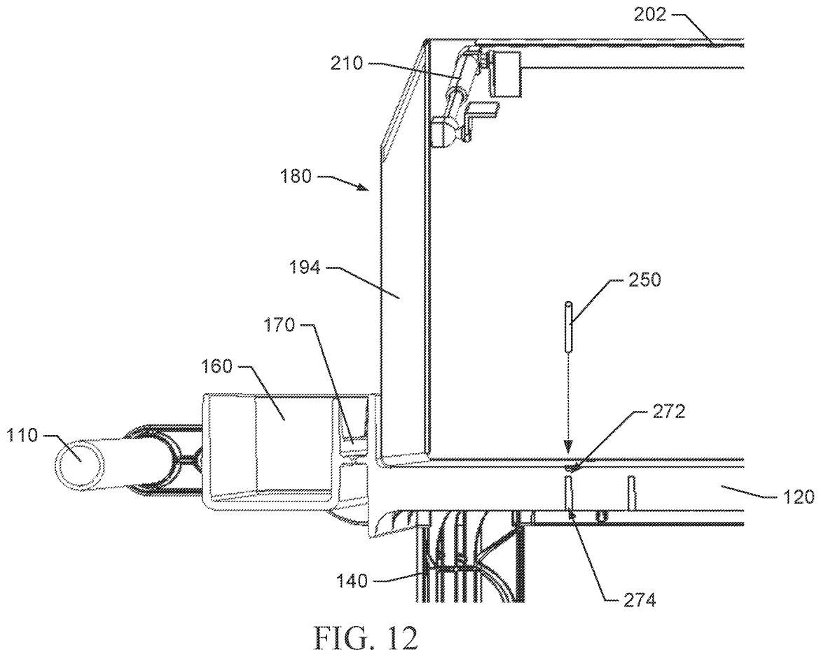

Referring now to FIGS. 8-12, the storage chest 180 may be secured to the top support platform 120 of the utility cart 100 via one or more fasteners 250 that may operably couple to the top support platform 120 through the bottom surface 192 of the storage chest 180. In this regard, the bottom surface 192 may include one or more fastener apertures 260 that may extend through the bottom surface 192. Responsive to the storage chest 180 being placed into the top support platform 120, the one or more fastener apertures 260 may align with one or more bosses 270 disposed in the top support platform 120. The one or more bosses 270 may be integrally formed into the top support platform 120 during a manufacturing process of the utility cart 100. In this regard, a bottom side of the top support platform 120, facing the bottom support platform 130, may include support ribs 280 that may provide structural support for the top support platform 120 during the manufacturing process. In such cases, the bosses 270 may be disposed at intersections of the support ribs 280. In an example embodiment, the support ribs 280 may extend along the bottom side of the top support platform 120 in various directions including laterally, longitudinally and diagonally across the bottom side. The support ribs 280 may also have a depth measured from the bottom side of the top support platform 120 toward the bottom support platform 130. In some cases, the one or more bosses 270 may include a protective membrane 272 and a bore 274. In this regard, the bore 274 may extend into the top support platform 120, and may be perpendicular to the bottom surface 192 of the storage chest 180. The protective membrane 272 may be disposed over the bore 274 at a surface of the top support platform 120 to cover an axial end of the bore 274. As such, the top support platform 120 may be formed such that it may include a mostly smooth and planar surface, but it may also include one or more small dimples where the protective membrane 272 may cover each of the one or more bosses 270. In this regard, the dimples may be approximately a few millimeters deep such that the top support platform 120 may still be substantially planar. In some cases, the bore 274 may extend to a same depth away from the top support platform 120 as the support ribs 280.

The one or more fasteners 250 may removably operably couple the storage chest 180 to the utility cart 100 by being inserted through the one or more fastener apertures 260 and into the bore 274 of the one or more bosses 270. In this regard, the one or more fasteners 250 may penetrate the protective membrane 272 of the one or more bosses 270 to operably couple to the bore 274 of the one or more bosses 270 responsive to being inserted through the one or more fastener apertures 260 and into the one or more bosses 270. Thus, in some embodiments, the protective membrane 272 may be a thin layer of material that may be readily broken or penetrated by the one or more fasteners 250. In other words, the protective membrane 272 need not be drilled out prior to installing the one or more fasteners 250. In an example case, the protective membrane 272 may be roughly 1-5 mm thick. In embodiments of the utility cart 100 that may not include a storage chest 180, the protective membrane 272 may prevent any smaller objects or any dust and debris from the top support platform 120 from entering the bore 274 and either getting stuck in the bore 274 or falling through the top support platform 120. In some cases, an interior surface of the bore 274 may be threaded to facilitate operable coupling with the one or more fasteners 250 accordingly. In other cases, the one or more fasteners 250 may be self-tapping, which is to say that they may use their own threads to dig into the interior surface of the bore 274 and remain operably coupled to the one or more bosses 270 accordingly. In an example embodiment, the one or more fasteners 250 may be either hand driven or tool driven into the bosses 270. In some cases, the depth of the bore 274 of the one or more bosses 270 may exceed the length of the one or more fasteners 250 that may be inserted therein. In this regard, the one or more fasteners 250 may not protrude out of the bottom of the bore 274 responsive to being inserted therein. In some cases, the top support platform 120 may include a plurality of additional bosses 270, some of which may be used for other accessories besides the storage chest 180.

In some example embodiments, the utility cart 100 may include an accessory support assembly 290. In this regard, the accessory support assembly 290 may include the handle 110, the extension arms 115, the top support platform 120, and the storage chest 180. The accessory support assembly 290 may be configured to retain additional accessories for the utility cart 100 therein or otherwise operably couple to additional accessories for the utility cart 100.

Some example embodiments may provide for a utility cart. The utility cart may include a handle via which a user may move the utility cart, a top support platform, to which the handle may be operably coupled, a bottom support platform which may be parallel to the top support platform, at least one upright support member which may operably couple the bottom support platform to the top support platform, a mobility assembly which may be operably coupled to the bottom support platform, and a storage chest which may be disposed within a perimeter of, and removably operably coupled to, the top support platform. The storage chest may be lockable to securely store objects inside the storage chest on the utility cart The utility cart of some embodiments may include additional, optional features, and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the storage chest may include a base portion which may include a bottom surface and a plurality of walls which may be disposed substantially perpendicularly to the bottom surface, and a lid which may be pivotably operably coupled to the plurality of walls and may be disposed a height of the plurality of walls away from the bottom surface. In some cases, the lid may be pivotable between an open position in which access into the base portion may be permitted by the lid and a closed position in which access into the base portion may be prohibited by the lid. In an example embodiment, the base portion may be formed from a single sheet of material continuously formed into the bottom surface and the plurality of walls. In some cases, in the closed position, the lid may be substantially parallel to the bottom surface. In an example embodiment, in the closed position, the lid may be angled relative to the bottom surface such that a first edge of the lid operably coupled to a hinge may be disposed above a second edge of the lid distal to the hinge. In some cases, the lid may include a retaining ledge which may be disposed proximate to the second edge of the lid. In an example embodiment, the retaining ledge may be configured to prevent objects from falling off the lid while the lid may be in the closed position. In some cases, the bottom surface may include a fastener aperture that may extend through the bottom surface. In an example embodiment, the fastener aperture may align with a boss disposed in the top support platform. In some cases, the boss may include a protective membrane and a bore. In an example embodiment, the bore may extend into the top support platform and the protective membrane may be disposed to cover an axial end of the bore at a surface of the top support platform. In some cases, a fastener may removably operably couple the storage chest to the utility cart. In an example embodiment, the fastener may penetrate the protective membrane of the boss to operably couple to the bore of the boss responsive to being inserted through the fastener aperture and into the boss.

Some example embodiments may provide for an accessory support assembly for a utility cart. The accessory support assembly may include a handle via which a user may move the utility cart, a top support platform, to which the handle may be operably coupled, at least one extension arm which may operably couple the handle to the top support platform, and a storage chest which may be shaped to be disposed within a perimeter of, and removably operably coupled to, the top support platform. The storage chest may be lockable to securely store objects inside the storage chest on the utility cart.

Some example embodiments may provide for a storage chest for a utility cart. The storage chest may include a base portion which may include a bottom surface and a plurality of walls disposed substantially perpendicularly to the bottom surface, and a lid which may be pivotably operably coupled to the plurality of walls and disposed a height of the plurality of walls away from the bottom surface. The storage chest may be shaped to be disposed within a perimeter of, and removably operably coupled to, a top support platform of the utility cart.

The storage chest may be lockable to securely store objects inside the storage chest on the utility cart. The lid may be pivotable between an open position in which access into the base portion may be permitted by the lid and a closed position in which access into the base portion may be prohibited by the lid.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A utility cart comprising:
a handle via which a user moves the utility cart;
a top support platform, to which the handle is operably coupled;
a bottom support platform disposed parallel to the top support platform;
a plurality of upright support members operably coupling the bottom support platform to the top support platform;
a mobility assembly operably coupled to the bottom support platform; and
a storage chest shaped to be disposed within a perimeter of, and removably operably coupled to, the top support platform.

2. The utility cart of claim 1, wherein the storage chest comprises:
a base portion having a bottom surface and a plurality of walls disposed substantially perpendicularly to the bottom surface; and
a lid pivotably operably coupled to the plurality of walls and disposed a height of the plurality of walls away from the bottom surface,
wherein the lid is pivotable between an open position in which access into the base portion is permitted by the lid and a closed position in which access into the base portion is prohibited by the lid.

3. The utility cart of claim 2, wherein in the closed position, the lid is substantially parallel to the bottom surface.

4. The utility cart of claim 3, wherein the base portion is formed from a single sheet of material continuously formed into the bottom surface and the plurality of walls.

5. The utility cart of claim 2, wherein in the closed position, the lid is angled relative to the bottom surface such that a first edge of the lid operably coupled to a hinge is disposed above a second edge of the lid distal to the hinge.

6. The utility cart of claim 5, wherein the lid comprises a retaining ledge disposed proximate to the second edge of the lid,
wherein the retaining ledge is configured to prevent objects from falling off the lid while the lid is in the closed position.

7. The utility cart of claim 2, wherein the bottom surface comprises a fastener aperture extending through the bottom surface.

8. The utility cart of claim 7, wherein the fastener aperture aligns with a boss disposed in the top support platform, and
wherein the boss comprises a protective membrane and a bore.

9. The utility cart of claim 8, wherein the bore extends into the top support platform and the protective membrane is disposed to cover an axial end of the bore at a surface of the top support platform.

10. The utility cart of claim 9, wherein a fastener removably operably couples the storage chest to the utility cart, and
wherein the fastener penetrates the protective membrane of the boss to operably couple to the bore of the boss responsive to being inserted through the fastener aperture and into the boss.

11. An accessory support assembly for a utility cart, the accessory support assembly comprising:
a handle via which a user moves the utility cart;
a top support platform, to which the handle is operably coupled;
at least one extension arm which operably couples the handle to the top support platform; and
a storage chest shaped to be disposed within a perimeter of, and removably operably coupled to, the top support platform,
wherein the storage chest is lockable to securely store objects inside the storage chest on the utility cart.

12. The accessory support assembly of claim 11, wherein the storage chest comprises:
a base portion having a bottom surface and a plurality of walls disposed substantially perpendicularly to the bottom surface; and
a lid pivotably operably coupled to the plurality of walls and disposed a height of the plurality of walls away from the bottom surface,
wherein the lid is pivotable between an open position in which access into the base portion is permitted by the lid and a closed position in which access into the base portion is prohibited by the lid.

13. The accessory support assembly of claim 12, wherein the bottom surface comprises a fastener aperture extending through the bottom surface.

14. The accessory support assembly of claim 13, wherein the fastener aperture aligns with a boss disposed in the top support platform, and
wherein the boss comprises a protective membrane and a bore.

15. The accessory support assembly of claim 14, wherein the bore extends into the top support platform and the protective membrane is disposed to cover an axial end of the bore at a surface of the top support platform.

16. The accessory support assembly of claim 15, wherein a fastener removably operably couples the storage chest to the utility cart, and
wherein the fastener penetrates the protective membrane of the boss to operably couple to the bore of the boss responsive to being inserted through the fastener aperture and into the boss.

17. A storage chest for a utility cart, the storage chest comprising:
a base portion having a bottom surface and a plurality of walls disposed substantially perpendicularly to the bottom surface; and
a lid pivotably operably coupled to the plurality of walls and disposed a height of the plurality of walls away from the bottom surface,
wherein the storage chest is shaped to be disposed within a perimeter of, and removably operably coupled to, a top support platform of the utility cart,
wherein the storage chest is lockable to securely store objects inside the storage chest on the utility cart, and
wherein the lid is pivotable between an open position in which access into the base portion is permitted by the lid and a closed position in which access into the base portion is prohibited by the lid.

18. The storage chest of claim 17, wherein the bottom surface comprises a fastener aperture extending through the bottom surface,
wherein the fastener aperture aligns with a boss disposed in the top support platform, and
wherein the boss comprises a protective membrane and a bore.

19. The storage chest of claim 18, wherein the bore extends into the top support platform and the protective membrane is disposed to cover an axial end of the bore at a surface of the top support platform.

20. The storage chest of claim 19, wherein a fastener removably operably couples the storage chest to the utility cart, and
wherein the fastener penetrates the protective membrane of the boss to operably couple to the bore of the boss responsive to being inserted through the fastener aperture and into the boss.
